(19) United States
(12) Patent Application Publication
(10) Pub. No.: US 2022/0089618 A1
(43) Pub. Date: Mar. 24, 2022

(54) Solid-State Synthesis Of Precursors Of Metal-Organic Frameworks

(71) Applicant: ExxonMobil Research and Engineering Company, Annandale, NJ (US)

(72) Inventors: Gerardo J. Majano, Basking Ridge, NJ (US); Joseph M. Falkowski, Hampton, NJ (US)

(21) Appl. No.: 17/417,418

(22) PCT Filed: Dec. 13, 2019
(86) PCT No.: PCT/US2019/066181

§ 371 Date: Jun. 23, 2021

Related U.S. Application Data
(60) Provisional application No. 62/798,004, filed on Jan. 29, 2019.

(51) Int. Cl. C07F 5/06; C01B 37/00

(52) U.S. Cl. CPC C07F 5/06; C01P 2004/03; C01B 37/00

(57) ABSTRACT

Metal-organic frameworks (MOFs) are highly porous entities comprising a multidentate ligand coordinated to multiple metal atoms, typically as a coordination polymer. MOFs are usually produced from a solvent in powder form under hydrothermal or solvothermal synthesis conditions. Alternately, powder-form precursors of MOFs may be formed by milling or mulling a substantially solid mixture of a metal salt and a multidentate organic ligand, optionally in the presence of a small amount of a solvent. The powder-form precursors may then undergo heating, typically in the absence of applied shear, to produce the corresponding MOF. Mulling may be differentiated from milling at least in that mulling applies to the substantially solid mixture at a non-constant pressure and milling applies a constant pressure while forming the powder-form precursor. In some cases, mulling may promote more effective formation of the powder-form precursor compared to milling.

### FIELD

The present disclosure relates to syntheses of metal-organic frameworks.

### BACKGROUND

Metal-organic frameworks (MOFs) are a relatively new class of highly porous materials with potential applications in a wide range of fields including gas storage, gas and liquid separations, isomer separation, waste removal, and catalysis, among others. In contrast to zeolites, which are purely inorganic in character, metal-organic frameworks comprise multidentate organic ligands that function as “struts” bridging metal atoms or clusters of metal atoms together in an extended coordination structure (e.g., as a coordination polymer). Like zeolites, metal-organic frameworks are microporous and exhibit a range of structures, including tunability of the pore shape and size through selection of the multidentate organic ligands and the metal. Tens of thousands of MOF structures are now known, compared to only a few hundred unique zeolite structures. Factors that may influence the structure of metal-organic frameworks include, for example, one or more of ligand denticity, size and type of the coordinating group(s), additional substitution remote or proximate to the coordinating group(s), ligand size and geometry, ligand hydrophobicity or hydrophilicity, choice of metal(s) and/or metal salt(s) and/or metal coordination compound(s), choice of solvent(s), and reaction conditions such as temperature, concentration, and the like. As used herein, the term “metal salt(s)” expressly includes embodiments in which at least one oxide of a metal cation may be present.

Metal-organic frameworks are typically synthesized by precipitation of microcrystalline powder materials from a liquid reaction medium under hydrothermal or solvothermal synthesis conditions, oftentimes at high dilution. Organic solvents are frequently used for conducting solvothermal syntheses of metal-organic frameworks, although some metal-organic frameworks may be synthesized hydrothermally using water as a solvent. The frequent requirement for a high-dilution reaction medium and associated solids separation processes during production of metal-organic frameworks may limit scalability for commercial syntheses and present cost barriers for various large-scale applications. Moreover, there may be environmental concerns associated with some organic solvents used in conjunction with synthesizing metal-organic frameworks, even if solvent recycling is conducted after completing the synthesis.

Solid-phase syntheses of metal-organic frameworks are described in U.S. Pat. No. 8,466,285. As described therein, grinding processes may impart sufficient activation energy to promote formation of certain metal-organic frameworks in a solid-phase reaction. The metal-organic frameworks may be porous or non-porous. U.S. Pat. No. 9,815,222 describes solid-phase reactions for synthesizing metal-organic frameworks using high-shear extrusion conditions. Localized heating during the mixing processes of these solid-phase syntheses may be problematic for some metal-organic frameworks, thereby leading to possible byproduct formation and/or MOF decomposition in some cases.

### SUMMARY

Powder-form precursors of metal-organic frameworks may be formed by mulling or milling operations. In various aspects, the present disclosure provides methods comprising: providing a substantially solid mixture comprising a metal salt and a multidentate organic ligand, and mulling or milling the substantially solid mixture for a sufficient length of time to produce a powder-form precursor of a metal-organic framework. The powder-form precursor comprises a reaction product of the metal salt and the multidentate organic ligand. The powder-form precursor is substantially free of the metal-organic framework.

In certain aspects, the present disclosure provides mulling-based methods for synthesizing metal-organic frameworks or precursors thereof. The methods comprise: providing a substantially solid mixture comprising a metal salt and a multidentate organic ligand, and mulling the substantially solid mixture at a non-constant pressure for a sufficient length of time to produce a powder-form precursor of a metal-organic framework. The powder-form precursor comprises a reaction product of the metal salt and the multidentate organic ligand. The powder-form precursor is substantially free of the metal-organic framework.

In other aspects, the present disclosure provides methods for converting a powder-form precursor of a metal-organic framework into the metal-organic framework. The methods comprise: providing a powder-form precursor of a metal-organic framework, and heating the powder-form precursor for a sufficient time and at a sufficient temperature to convert the powder-form precursor into the metal-organic framework. The powder-form precursor comprises a reaction product of the metal salt and the multidentate organic ligand. The powder-form precursor is substantially free of the metal-organic framework.

In still further aspects, the present disclosure provides powder-form precursors of metal-organic frameworks that are prepared by a process comprising: providing a substantially solid mixture comprising a metal salt and a multidentate organic ligand, and mulling or milling the substantially solid mixture for a sufficient length of time to produce a powder-form precursor of a metal-organic framework. The powder-form precursor comprises a reaction product of the metal salt and the multidentate organic ligand. The powder-form precursor is substantially free of the metal-organic framework.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one of ordinary skill in the art and having the benefit of this disclosure.

FIG. 1 shows overlaid x-ray powder diffraction patterns for a powder-form precursor of MIL-101 (Cr) obtained by mulling and the corresponding metal-organic framework obtained after heating several precursor variants.

FIG. 2A shows an SEM image of MIL-101 (Cr) produced by heating a powder-form precursor mulled without solvent. FIGS. 2B-2D show SEM images of MIL-101 (Cr) produced by heating a powder-form precursor mulled with DMF, water, or ethanol, respectively.

FIG. 3 shows overlaid x-ray powder diffraction patterns for a powder-form precursor of MIL-101 (Cr) obtained by milling and the corresponding metal-organic framework obtained after heating several precursor variants.

FIG. 4A shows an SEM image of MIL-101 (Cr) produced by heating a powder-form precursor milled without solvent. FIGS. 4B-4D show SEM images of MIL-101 (Cr) produced by heating a powder-form precursor milled with DMF, water, or ethanol, respectively.

FIG. 5 shows overlaid x-ray powder diffraction patterns for a powder-form precursor of MIL-53 (Al) obtained by mulling a mixture of aluminum nitrate and terephthalic acid and the corresponding metal-organic framework obtained after heating several precursor variants.

FIG. 6A shows an SEM image of MIL-53 (Al) produced by heating a powder-form precursor obtained by mulling a mixture of aluminum nitrate and terephthalic acid without solvent. FIGS. 6B-6D show SEM images of MIL-53 (Al) produced by heating a powder-form precursor obtained by mulling a mixture of aluminum nitrate and terephthalic acid with DMF, water, or ethanol, respectively.

FIG. 7 shows overlaid x-ray powder diffraction patterns for a powder-form precursor of MIL-53 (Al) obtained by mulling a mixture of aluminum hydroxide and terephthalic acid and the corresponding metal-organic framework obtained after heating several precursor variants.

FIG. 8A shows an SEM image of MIL-53 (Al) produced by heating a powder-form precursor obtained by mulling a mixture of aluminum hydroxide and terephthalic acid without solvent. FIGS. 8B-8D show SEM images of MIL-53 (Al) produced by heating a powder-form precursor obtained by mulling a mixture of aluminum hydroxide and terephthalic acid with DMF, water, or ethanol, respectively.

### DETAILED DESCRIPTION

The present disclosure generally relates to metal-organic frameworks and, more specifically, to solid-phase syntheses of precursors of metal-organic frameworks.

As discussed above, wet-chemical syntheses of metal-organic frameworks may require high dilution conditions and possible organic solvent recycling. These factors may complicate production of metal-organic frameworks in sufficient quantities to support various large-scale applications. Alternative solid-phase syntheses of certain metal-organic frameworks are known. However, localized heating while blending a solid mixture of a metal salt and a multidentate ligand may be problematic in various respects during solid-phase syntheses. Namely, localized heating occurring during direct syntheses of metal-organic frameworks produced via solid-phase syntheses may lead to byproduct formation and/or at least partial decomposition of the metal-organic framework.

In contrast to conventional solid-phase syntheses for producing metal-organic frameworks, the present disclosure provides solid-phase syntheses of powder-form precursors of metal-organic frameworks that may undergo subsequent thermal conversion into finished metal organic frameworks. Surprisingly, blending a metal salt and a multidentate organic ligand together under suitably mild mixing conditions may lead to formation of a phase differing from both the metal salt and the multidentate organic ligand (powder-form precursor) and yet that is still not the metal-organic framework formed under more energetic mixing conditions. Further surprisingly, the powder-form precursor may be at least partially crystalline following blending. Advantageously, the thermal conditions used for converting the powder-form precursor into the corresponding metal-organic framework may be more carefully controlled than those in conventional solid-phase syntheses wherein metal-organic frameworks are produced directly during energetic blending or extrusion. The greater thermal control afforded by the disclosure herein may decrease byproduct formation and/or limit metal-organic framework decomposition.

Advantageously, the methods described herein allow metal-organic frameworks to be synthesized while using no or very minimal quantities of organic solvents or water while conducting the syntheses. Minimizing solvent use according to the disclosure herein may provide a superior economic and environmental profile compared to conventional hydrothermal or solvothermal metal-organic framework synthetic methods. Namely, by avoiding high-dilution synthetic conditions, the methods disclosed herein are much more amenable to scale-up than are conventional hydrothermal or solvothermal methods for synthesizing metal-organic frameworks. Surprisingly, including a small amount of solvent in an otherwise solid mixture of reactants may lead to an advantageous increase in surface area following formation of the metal-organic framework. Different solvents may provide a variable extent of surface area modification. In addition, inclusion of a small amount of a suitable solvent may afford formation of one or more different crystalline phases as well.

The methods of the present disclosure further share certain benefits in common with conventional solid-phase syntheses of metal-organic frameworks (e.g., scalability and limited solvent use), but without exhibiting the drawbacks associated with energetic solid-phase blending to produce the metal-organic frameworks directly. As addressed above, the methods disclosed herein blend a metal salt and a multidentate organic ligand under mild mixing conditions to produce a powder-form precursor substantially lacking the corresponding metal-organic framework. Under appropriate conditions, both mulling and milling operations may be used to produce the powder-form precursor, as addressed further hereinbelow. Subsequent conversion of the powder-form precursor into the corresponding metal-organic framework may be accomplished with decreased byproduct formation and/or metal-organic framework decomposition than may be typical for conventional solid-phase syntheses of these entities.

A still further advantage of the methods disclosed herein is that a powder-form precursor of a metal-organic framework may be collected and potentially stored until conversion into the corresponding metal-organic framework is desired at a later time. Optionally, the powder-form precursor may be manipulated (formed) into a desired shape and/or mixed with a binder, such as a within a mold or similar structure, to afford the metal-organic framework in a defined shape following heating to convert the powder-form precursor into the corresponding metal-organic framework. The powder-form precursor may be pressed or extruded into a desired shape in some instances.

Before describing the methods of the present disclosure in further detail, a listing of terms follows to aid in better understanding the present disclosure.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A”, and “B.”

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides).

As used herein, the term “substantially solid” refers to either a dry powder lacking solvent or a solvent-wetted dry powder in which solid particulates or a portion thereof are wetted with a solvent but the solid particulates are not separated or dispersed from one another by a continuous solvent phase.

As used herein, the term “multidentate” refers to a compound having two or more potential sites for coordinating a metal ion. Accordingly, the term “multidentate” encompasses bidentate, tridentate, tetradentate, and higher denticity ligands.

As used herein, the term “substantially free of” refers to a mass percentage under about 5 wt. %.

As used herein, the terms “mill,” “milling,” and other grammatical forms thereof refer to a blending process in which a mixture of powder materials is mixed under a constant amount of mechanically applied pressure.

As used herein, the terms “mull,” “mulling,” and other grammatical forms thereof refer to a blending process in which a mixture of powder materials is mixed under a non-constant amount of mechanically applied pressure. Mulling is differentiated from milling in that mulling is less energetic and is less prone toward producing localized heating at the point of contact between the powder materials and the mulling head of a mutter.

According to some embodiments of the present disclosure, methods for producing a powder-form precursor of a metal-organic framework are disclosed herein. Certain methods of the present disclosure may comprise: providing a substantially solid mixture comprising a metal salt and a multidentate organic ligand, and mulling or milling the substantially solid mixture for a sufficient length of time to produce a powder-form precursor of a metal-organic framework, in which the powder-form precursor is substantially free of the metal-organic framework and comprises a reaction product of the metal salt and the multidentate organic ligand.

As described above, milling may take place at a constant pressure and mulling may take place at a non-constant pressure. More specifically, in some embodiments, the substantially solid mixture may be milled and milling may take place at a constant pressure applied upon the substantially solid mixture by a mill. In other embodiments, the substantially solid mixture may be mulled and mulling may take place at a non-constant pressure applied upon the substantially solid mixture by a mull. The milling or mulling applies a sufficient input of energy to the substantially solid mixture of the metal salt and the multidentate organic ligand, such that the substantially solid mixture undergoes a reaction to produce the powder-form precursor of the metal-organic framework. The chemical nature of the powder-form precursor may vary for different metal-organic frameworks, and may comprise a partially coordinated coordination copolymer, possibly in a layered structure, that is capable of being converted into the corresponding metal-organic framework with full metal coordination upon undergoing further heating. Conversion into the metal-organic framework may relax stresses that are present in the powder-form precursor. According to the present disclosure, milling or mulling is not understood to input sufficient energy to the substantially solid mixture to promote direct formation of the metal-organic framework itself. Because synthesis does not take place directly under intense milling, the present disclosure may avoid formation of an extremely dense crystalline phase having minimal porosity, which may be undesirable for various applications. Alternately, an intermediate metal-organic framework may be formed under the milling or mulling conditions, with the intermediate metal-organic framework undergoing subsequent conversion into a final metal-organic framework of interest.

Suitable mills for performing the disclosure herein may include, for example, ball mills, rod mills, autogenic mills, semi-autogenic mills, pebble mills, rolling mills, and the like.

Suitable milers for performing the disclosure herein may include, for example, roller millers. Pressures applied to the substantially solid mixture during mulling may be a constant pressure falling within a range from about 0.14 to about 50 kN, or from about 0.14 to about 24 kN, or from about 24 to about 50 kN.

Milling or mulling the substantially solid mixture may take place at a temperature ranging from about 0° C. to about 70° C., or about 25° C. to about 70° C., or about 35° C. to about 65° C.

Mulling or milling the substantially solid mixture of the metal salt and the multidentate organic ligand may take place over a period of time wherein formation of the precursor the metal-organic framework is substantially complete and no substantial formation of the corresponding metal-organic framework occurs. Sufficient times for mulling the substantially solid mixture to produce the powder-form precursor may range from about 1 minute to about 12 hours, or about 5 minutes to about 4 hours, or about 5 minutes to about 1.5 hours, or about 10 minutes to about 1 hour.

In some embodiments, the substantially solid mixture may lack a solvent and consist essentially of the metal salt and the multidentate organic ligand. It is to be appreciated that certain multidentate organic ligands may be liquids at room temperature or at the temperature at which milling or mulling takes place. According to the disclosure herein, even when a liquid multidentate organic ligand is present, a mixture of the metal salt and the multidentate ligand will still be considered to constitute a substantially solid mixture of the two.

It is also to be appreciated that small amounts of solvent may be present in combination with the metal salt and the multidentate organic ligand while still maintaining a substantially solid mixture of the two. As used herein, the term “solvent” refers to any compound that is a liquid at room temperature or at the temperature of milling or mulling. Typically, the solvent is present in an amount to provide wetting of at least a portion of the metal salt and/or the multidentate organic ligand. The solvent may or may not promote dissolution or partial dissolution of the metal salt and/or the multidentate organic ligand when included in such amounts. In particular embodiments, the solvent is present in an amount such that the mixture of the metal salt and the multidentate organic ligand still appears to be substantially solid in character or at most a wet slurry. In particular embodiments, an amount of solvent in the mixture of the metal salt and the multidentate organic ligand may be about 20 μL or above, or about 100 μL or above, or about 500 μL or above, or about 1000 μL or above per gram of a combined amount of the metal salt and the multidentate organic ligand. In still more particular embodiments, an amount of the solvent in the substantially solid mixture may range from about 20 μL to about 1000 μL, or from about 20 μL to about 500 μL, or from about 20 μL to about 100 μL, or from about 20 μL to about 60 μL or from about 40 μL to about 80 μL per gram of a combined amount of the metal salt and the multidentate organic ligand.

Solvents that may be suitably included in the substantially solid mixture are not considered to be particularly limited, provided that they do not inhibit formation of the powder-form precursor and/or the corresponding metal-organic framework. In particular embodiments, suitable solvents may include, for example, water, protic organic solvents such as methanol, ethanol or other alcohols, or aprotic organic solvents such as acetone or N,N-dimethylformamide (DMF).

According to some more specific embodiments, methods of the present disclosure may comprise providing a substantially solid mixture comprising a metal salt and a multidentate organic ligand, and mulling the substantially solid mixture at a non-constant pressure applied by a muller for a sufficient length of time to produce a powder-form precursor of a metal-organic framework, in which the powder-form precursor is substantially free of the metal-organic framework and comprises a reaction product of the metal salt and the multidentate organic ligand.

The metal-organic frameworks that may be produced according to the disclosure herein are not considered to be particularly limited. The metal-organic frameworks produced according to the disclosure herein may represent presently known metal-organic frameworks or metal-organic frameworks that are presently unknown. For metal-organic frameworks that are presently known, one having ordinary skill in the art will be able to select a suitable metal salt and a suitable multidentate organic ligand for producing the metal-organic framework, with one's selections being guided by wet chemical methods for producing the metal-organic framework. Accordingly, a wide range of metal salts and multidentate organic ligands may be present when forming a precursor of a metal-organic framework according to the disclosure herein, as described hereinafter.

Metal salts that may be present in the substantially solid mixture may be any metal salt that is capable of forming a metal-organic framework. Suitable metal salts may include metal ions such as, but not limited to, Mg²⁺, Ca²⁺, Sr²⁺, Ba²⁺, Sc³⁺, Y³⁺, Ti⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re²⁺, Re³⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Ti³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺ and Bi⁺. Other oxidation states of these metal ions may also be suitably used in some instances. Suitable counterion forms for the metal ions may include, but are not limited to, nitrate, nitrite, sulfate, hydrogen sulfate, oxide, acetate, formate, oxide, hydroxide, benzoate, alkoxide, carbonate, acetylacetonoate, hydrogen carbonate, fluoride, chloride, bromide, iodide, phosphate, hydrogen phosphate, dihydrogen phosphate, or the like.

Bidentate or higher denticity organic ligands that may be present in the substantially solid mixture are similarly not considered to be particularly limited. Heteroatoms such as O, N, S or P may comprise a binding site for metal ion complexation in the ligands in the metal-organic framework. Particular functional groups that may suitably complex a metal ion include, but are not limited to, —CO₂H, —CS₂H, —NO₂, —OH, —SH, —SO₃H, —Si(OH)₃, —Ge(OH)₃, —Sn(OH)₃, —PO₃H, —AsO₃H, —CN, —NH₂, —NHR, and —NR₂ (R=alkyl or aryl). Illustrative bidentate organic ligands may comprise one or more of an alkyl group substructure having from 1 to 10 carbon atoms, an aryl group substructure having from 1 to 5 phenyl or naphthyl rings and/or 1 to 5 heteroaromatic rings, an alkyl or aryl amine substructure comprising alkyl groups having from 1 to 10 carbon atoms or aryl groups having from 1 to 5 phenyl or naphthyl rings and/or 1 to 5 heteroaromatic rings, in which one or more of the substructures have bound thereto at least one and typically more than one functional group capable of bidentate bonding. In still more specific examples, two or more of such groups may be attached to an organic group, Z which may be an alkylene group having 1, 2, 3, 4 or 5 carbon atoms such as, for example, a methylene, ethylene, n-propylene, i-propylene, n-butylene, i-butylene, t-butylene or n-pentylene group or an aryl group containing one or two aromatic rings.

More particular examples of multidentate organic ligands that may be used to form precursors of metal-organic frameworks according to the disclosure herein include, for example, 1,4-butanedicarboxylic acid, tartaric acid, glutaric acid, oxalic acid, 4-oxo-pyran-2, 6-dicarboxylic acid, 1,6-hexanedicarboxylic acid, decane dicarboxylic acid, 1,8-heptadecane dicarboxylic acid, 1,9-heptadecanedicarboxylic acid, heptadecanedicarboxylic acid, acetylene dicarboxylic acid, 1,2-benzenedicarboxylic acid, 2,3-pyridinedicarboxylic acid, 1,3-butadiene-1,4-dicarboxylic acid, 1,4-benzenedicarboxylic acid, 1,3-benzenedicarboxylic acid, imidazole-2,4-dicarboxylic acid, 2-methyl-quinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethan-3,3′-dicarboxylic acid, quinoline-3,4-dicarboxylic acid, 7-chloro-4-hydroxyquinoline-2,8-dicarboxylic acid, pyridine-2,6-dicarboxylic acid, 2-methylimidazole-4,5-dicarboxylic acid, thiophene-3,4-dicarboxylic acid, 2-isopropyl-4,5-dicarboxylic acid, tetrahydropyrane-4,4-dicarboxylic acid, perylene-3,9-dicarboxylic acid, polyethylenegylcol dicarboxylic acids, 3,6-dioxaoctanedicarboxylic acid, 3,5-cyclohexadiene-1,2-dicarboxylic acid, octanecarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis-(phenylamino)-benzene-2,5-dicarboxylic acid, 1-1′-dinaphthyl-8,8′-dicarboxylic acid, 7-chloro-8-methylquinoline-2,3-dicarboxylic acid, 1-anilinoanthraquinone-2,4′-dicarboxylic acid, polytetrahydrofuran-2,5-dicarboxylic acid, 1,4-bis-(carboxymethyl)-piperazin-2,3-dicarboxylic acid, 7-chloroquinoline-3,8-dicarboxylic acid, 1-(4-carboxy)-phenyl-3-(4-chloro)-phenyl-pyrazolin-4,5-dicarboxylic acid, 1,4,5,6,7,7-hexachloro-5-norbornene-2,3-dicarboxylic acid, phenylindanedicarboxylic acid, 1,3-dibenzyl-2-oxo-imidazolidine-4,5-dicarboxylic acid, 1,4-cyclohexanedicarboxylic acid, naphthalene-1,8-dicarboxylic acid, 2-benzoylbenzol-1,3-dicarboxylic acid, 1,3-dibenzyl-2-oxo-imidazolidine-4,5-cis-dicarboxylic acid, 2,2′-biquinoline-4,4′-di-carboxylic acid, pyridine-3,4-dicarboxylic acid, 3,6,9-trioxaundecanedicarboxylic acid, hydroxy-benzophenone-dicarboxylic acids, pyrazole-3,4-dicarboxylic acid, 2,3-pyrazinedicarboxylic acid, 5,6-dimethyl-2,3-pyrazine dicarboxylic acid, 4,4′-diaminodiphenyl ether-di-imidedicarboxylic acid, 4,4′-diaminodiphenylmethanediimidedicarboxylic acid, 4,4′-diamino-diphenylsulfone diimidedicarboxylic acid, 2,6-naphthalene dicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedioic acid, 8-sulfo-2,3-naphthalindicarboxylic acid, anthracene-2,3-dicarboxylic acid, 2′,3′-diphenyl-p-terphenyl-4,4′-dicarboxylic acid, diphenyl-4,4′-dicarboxylic acid, imidazole-4,5-dicarboxylic acid, 4 (1H)-oxo-thiochromen-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontandicarboxylic acid, tetradecanedicarboxylic acid, 1,7-heptanedicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorfluorubin-4,11-dicarboxylic acid, 7-chloro-3-methylquinoline-6,8-dicarboxylic acid, 2,4-dichlorobenzophenone-2′5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecane-5,6-dehydronorbornan-2,3-dicarboxylic acid, 5-ethyl-2,3-pyridinedicarboxylic acid, 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propane-4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, aurinetricarboxylic acid, 1,1-dioxide-perylo[1,12-BCD]thiophene-3,4,9,10-tetracarboxylic acid, perylenetetracarboxylic acids, perylene-3,4,9,10-tetracarboxylic acid, perylene-1,12-sulfone-3,4,9,10-tetracarboxylic acid, butanetetracarboxylic acids, 1,2,3,4-butanetetracarboxylic acid, meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofilrantetracarboxylic acid, and cyclopentanetetracarboxylic acids such as cyclopentane-1,2,3,4-tetracarboxylic acid.

Other examples of multidentate organic ligands that may be present in the substantially solid mixture include, for example, imidazolates such as 2-methyl-imidazolate, acetylenedicarboxylic acid, camphordicarboxylic acid, fumaric acid, succinic acid, benzenedicarboxylic acids such as phthalic acid, isophthalic acid, terephthalic acid, aminoterephthalic acid, triethylenediamine, methylglycinediacetic acid, naphthalenedicarboxylic acids, biphenyldicarboxylic acids such as 4,4′-biphenyldicarboxylic acid, pyrazinedicarboxylic acids such as 2,5-pyrazinedicarboxylic acid, bipyridinedicar-boxylic acids such as 2,2′-bipyridinedicarboxylic acids, including 2,2′-bipyridine-5,5′-dicarboxylic acid, benzenetricarboxylic acids, including 1,2,3-benzenetricarboxylic acid, 1,2,4-benzenetricarboxylic acid or 1,3,5-benzenetricarboxylic acid, benzenetetracarboxylic acids, adamantanetetracarboxylic acid, adamantanedibenzoate, benzenetribenzoate, methanetetrabenzoate, adamantanetetrabenzoate, dihydroxyterephthalic acids such as 2,5-dihydroxyterephthalic acid, tetrahydropyrene-2,7-dicarboxylic acid, biphenyltetracarboxylic acid, and 1,3-bis(4-pyridyl)propane.

Besides the multidentate organic ligand, one or more monodentate ligands may also be present in the substantially solid mixture and in the precursors and/or metal-organic frameworks formed therefrom. Suitable monodentate ligands may include, for example, alkyl amines and their corresponding alkyl ammonium salts containing linear, branched, or cyclic aliphatic groups, having from 1 to 20 carbon atoms; aryl amines and their corresponding aryl ammonium salts having from 1 to 5 phenyl or naphthyl rings and/or 1 to 5 heteroaromatic rings; alkyl phosphonium salts containing linear, branched, or cyclic aliphatic groups, having from 1 to 20 carbon atoms; aryl phosphonium salts having from 1 to 5 phenyl or naphthyl rings and/or 1 to 5 heteroaromatic rings; alkyl organic acids and the corresponding alkyl organic anions (including salts thereof) containing linear, branched, or cyclic aliphatic groups, having from 1 to 20 carbon atoms; aryl organic acids and the corresponding aryl organic anions (including salts thereof) having from 1 to 5 phenyl or naphthyl rings and/or 1 to 5 heteroaromatic rings; aliphatic alcohols containing linear, branched, or cyclic aliphatic groups, having from 1 to 20 carbon atoms; aryl alcohols having from 1 to 5 phenyl or naphthyl rings and/or 1 to 5 heteroaromatic rings; inorganic anions including, for example, sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, and the corresponding acids and salts of the aforementioned inorganic anions. Miscellaneous ligands such as water, ammonia, carbon dioxide, oxygen, ethylene, hexane, tetrahydrofuran, ethanolamine, triethylamine and trifluoromethanesulfonic acid may also be suitably present in the substantially solid mixture or in the precursors and/or metal-organic frameworks formed therefrom.

Methods of the present disclosure may further comprise heating the powder-form precursor of the metal-organic framework for a sufficient time and at a sufficient temperature to convert the powder-form precursor into the corresponding metal-organic framework. In more specific embodiments, heating may take place without applying shear to the powder-form precursor, particularly given that the powder-form precursor may be isolated following milling or mulling but before undergoing further transformation. Suitable temperatures for converting the powder-form precursor into the corresponding metal-organic framework include temperatures up to about 200° C., or up to about 180° C., or up to about 150° C. In more particular embodiments, the powder-form precursor may be heated at a temperature ranging from about 50° C. to about 200° C., or about 100° C. to about 200° C., or about 100° C. to about 150° C., or about 150° C. to about 200° C. Suitable temperatures for converting the powder-form precursor into the corresponding metal-organic framework may include heating times up to about 24 hours, or up to about 12 hours, or up to about 6 hours, or up to about 2 hours, or up to about 1 hour. In particular embodiments, suitable heating times may range from about 30 minutes to about 12 hours, or about 1 hour to about 10 hours, or about 2 hours to about 6 hours. Heating may take place under a variety of conditions, including under vacuum, in a static or flowing inert gas, or in air.

Metal-organic frameworks may have a pore size that is defined by both the metal and the multidentate organic ligand. Pore sizes may be comparable to those produced during wet chemical syntheses of the metal-organic frameworks. Both microporosity and mesoporosity may be present within the metal-organic frameworks obtained after heating. Micropores are defined herein as having a pore size of about 2 nm or below, and mesopores are defined herein as having a pore size from about 2 nm to about 50 nm. Microporosity and/or mesoporosity may be determined by analysis of the nitrogen adsorption isotherm at 77 K, as will be understood by one having ordinary skill in the art. BET surface areas of the metal-organic frameworks may also be determined from the nitrogen adsorption isotherm. The BET surface area may be impacted, sometimes considerably, depending upon whether a solvent is present while mulling or mixing the substantially solid mixture of the metal salt and the multidentate organic ligand.

In some or other embodiments, methods of the present disclosure may comprise forming or manipulating the powder-form precursor into a shaped body prior to heating. Optionally, the powder-form precursor may be combined with a binder material prior to being shaped. The shaping process may promote conversion of the precursor into the corresponding metal-organic framework, or conversion of the precursor to the corresponding metal-organic framework may occur after shaping and during heating.

Accordingly, other particular embodiments of the present disclosure may comprise: providing a powder-form precursor of a metal-organic framework, in which the powder-form precursor is substantially free of the metal-organic framework and comprises a reaction product of a metal salt and a multidentate organic ligand, and heating the powder-form precursor for a sufficient time and at a sufficient temperature to convert the powder-form precursor into the metal-organic framework. Suitable heating times and temperatures needed for converting the powder-form precursor into the corresponding metal-organic framework are provided hereinabove. In more particular embodiments, heating may take place without applying shear to the powder-form precursor while converting the powder-form precursor into the corresponding metal-organic framework.

In particular embodiments, providing the powder-form precursor may comprise milling a substantially solid mixture of the metal salt and the multidentate organic ligand at a constant pressure applied by a mill. In other particular embodiments, providing the powder-form precursor may comprise mulling a substantially solid mixture of the metal salt and the multidentate organic ligand at a non-constant pressure applied by a muller. Particular details concerning mulling and milling operations are disclosed hereinabove.

Embodiments disclosed herein include:

A. Methods for forming a powder-form precursor of a metal-organic framework. The methods comprise: providing a substantially solid mixture comprising a metal salt and a multidentate organic ligand; and mulling or milling the substantially solid mixture for a sufficient length of time to produce a powder-form precursor of a metal-organic framework, the powder-form precursor being substantially free of the metal-organic framework and comprising a reaction product of the metal salt and the multidentate organic ligand.

B. Methods for forming a powder-form precursor of a metal-organic framework by mulling. The methods comprise: providing a substantially solid mixture comprising a metal salt and a multidentate organic ligand; and mulling the substantially solid mixture at a non-constant pressure applied by a muller for a sufficient length of time to produce a powder-form precursor of a metal-organic framework, the powder-form precursor being substantially free of the metal-organic framework and comprising a reaction product of the metal salt and the multidentate organic ligand.

C. Methods for converting a powder-form precursor of a metal-organic framework into the corresponding metal-organic framework. The methods comprise: providing a powder-form precursor of a metal-organic framework, the powder-form precursor being substantially free of the metal-organic framework and comprising a reaction product of a metal salt and a multidentate organic ligand; and heating the powder-form precursor for a sufficient time and at a sufficient temperature to convert the powder-form precursor into the metal-organic framework.

D. Powder-form precursors of a metal-organic framework. The precursors comprise: providing a substantially solid mixture comprising a metal salt and a multidentate organic ligand; and mulling or milling the substantially solid mixture for a sufficient length of time to produce a powder-form precursor of a metal-organic framework, the powder-form precursor being substantially free of the metal-organic framework and comprising a reaction product of the metal salt and the multidentate organic ligand.

Embodiments A-D may have one or more of the following additional elements in any combination:

Element 1: wherein the substantially solid mixture is milled and milling takes place at a constant pressure applied upon the substantially solid mixture by a mill.

Element 2: wherein the substantially solid mixture is mulled and mulling takes place at a non-constant pressure applied upon the substantially solid mixture by a muller.

Element 3: wherein the substantially solid mixture further comprises a solvent.

Element 4: wherein an amount of the solvent in the substantially solid mixture is about 20 μL or above per gram of a combined amount of the metal salt and the multidentate organic ligand.

Element 5: wherein the powder-form precursor is at least partially crystalline.

Element 6: wherein the method further comprises: heating the powder-form precursor for a sufficient time and at a sufficient temperature to convert the powder-form precursor into the metal-organic framework; wherein heating takes place without applying shear to the powder-form precursor.

Element 7: wherein the method further comprises: forming the powder-form precursor into a shaped body prior to heating.

Element 8: wherein providing the powder-form precursor comprises milling a substantially solid mixture of the metal salt and the multidentate organic ligand at a constant pressure applied by a mill.

Element 9: wherein providing the powder-form precursor comprises mulling a substantially solid mixture of the metal salt and the multidentate organic ligand at a non-constant pressure applied by a muller.

Element 10: wherein heating takes place without applying shear to the powder-form precursor.

Element 11: wherein the powder-form precursor is produced in the presence of a solvent.

Element 12: wherein the substantially solid mixture is milled and milling takes place at a constant pressure applied upon the substantially solid mixture by a mill.

Element 13: wherein the substantially solid mixture is mulled and mulling takes place at a non-constant pressure applied upon the substantially solid mixture by a muller.

By way of non-limiting example, exemplary combinations applicable to A include 1 and 3; 1, 3 and 4; 1 and 5; 1 and 6; 1 and 7; 2 and 3; 2, 3 and 4; 2 and 5; 2 and 6; 2 and 7; 3 and 4; 3-5; 3 and 6; 3 and 7; 5 and 6; 5 and 7; and 6 and 7. By way of further non-limiting example, exemplary combinations applicable to B include 3 and 4; 3 and 5; 3-5; 3 and 6; 3 and 7; 5 and 6; 5 and 7; and 6 and 7. By way of still further non-limiting example, exemplary combinations applicable to C include 7 and 8; 8 and 10; 8 and 11; 7 and 9; 9 and 10; and 9 and 11. By way of yet still further non-limiting example, exemplary combinations applicable to D include 5 and 11; 5 and 12; 5 and 13; 11 and 12; and 11 and 13.

To facilitate a better understanding of the embodiments described herein, the following examples of various representative embodiments are given. In no way should the following examples be read to limit, or to define, the scope of the present disclosure.

### EXAMPLES

General Mulling Synthesis Conditions. In a typical synthesis, suitable quantities of a metal salt and a multidentate organic ligand were combined together with one another as solids (1 g of total solids). Optionally, 40 μL of solvent (2 drops per gram of metal salt and multidentate organic ligand solids) was added to the mixture. Thereafter, the mixture was blended in either a HTME bench scale muller or a conventional Lancaster muller at room temperature for a predetermined period of time (7-30 minutes depending on batch size). The initially produced powder-form precursor of the metal-organic framework was then removed from the muller and heated for a predetermined period of time at temperatures up to about 200° C. to convert the powder-form precursor into the corresponding metal-organic framework. Heating was conducted in a conventional oven under ambient atmosphere until formation of the metal-organic framework was complete.

The powder-form precursor and the corresponding metal-organic framework were characterized by x-ray powder diffraction using Cu K(α) x-ray radiation and a Bruker D8 Advance diffractometer. BET surface areas of the metal-organic frameworks were measured from the N₂ adsorption isotherm at 77 K.

### Example 1: Mulling-Based Synthesis of MIL-101 (Cr)

The general conditions above were used to synthesize the metal-organic framework MIL-101 (Cr) by combining a Cr³⁺ salt (chromium (III) nitrate nonahydrate) and terephthalic acid. The mixture was mulled without adding solvent. The resulting powder-form precursor was collected and analyzed by x-ray powder diffraction. X-ray powder diffraction did not show substantial formation of MIL-101 (Cr). Thereafter, the powder-form precursor was heated in a Teflon-lined stainless steel autoclave for 4 hours at 200° C. Heating was conducted in some instances after adding approximately 20 μL of water, N,N-dimethylformamide (DMF) or ethanol. The resulting product was again analyzed by x-ray powder diffraction and the BET surface area was determined.

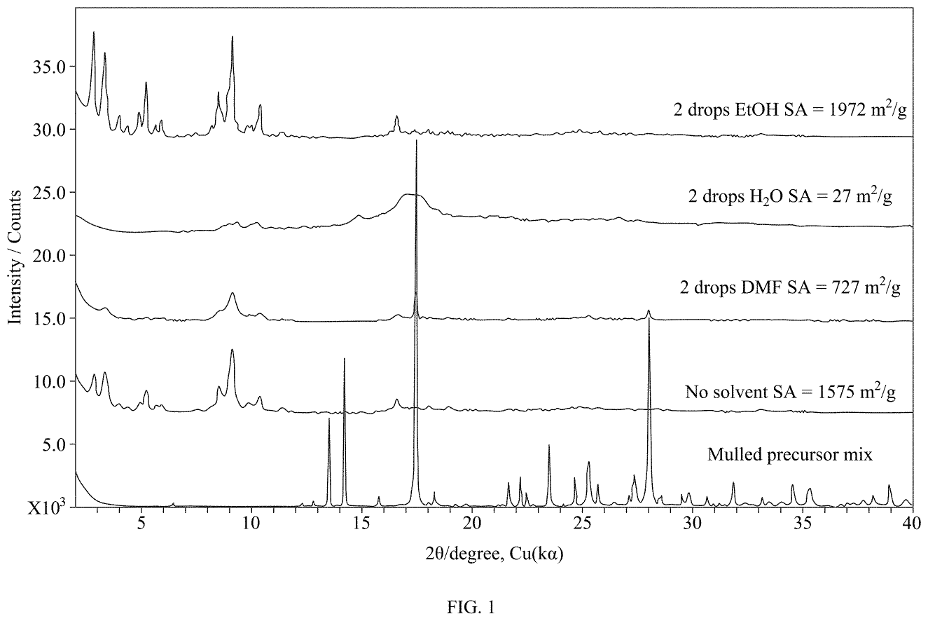

FIG. 1 shows overlaid x-ray powder diffraction patterns for a powder-form precursor of MIL-101 (Cr) obtained by mulling and the corresponding metal-organic framework obtained after heating several precursor variants. As shown, the powder-form precursor exhibited a considerably different x-ray diffraction pattern than did the products obtained after heating. Specifically, after heating the x-ray powder diffraction patterns were characterized by ingrowth of peaks at 20 values of approximately 5.20, 8.49, 9.13, and 10.39 degrees, whereas none of these peaks were present in the powder form precursor. The MIL-101 (Cr) formed without solvent and in the presence of ethanol exhibited considerable crystallinity, as shown by the sharpness of the x-ray powder diffraction peaks, whereas the MIL-101 (Cr) formed in the presence of DMF or water was considerably less crystalline. The BET surface areas of the MIL-101 (Cr) formed without solvent or in the presence of ethanol were also significantly higher than those formed in the presence of DMF or water.

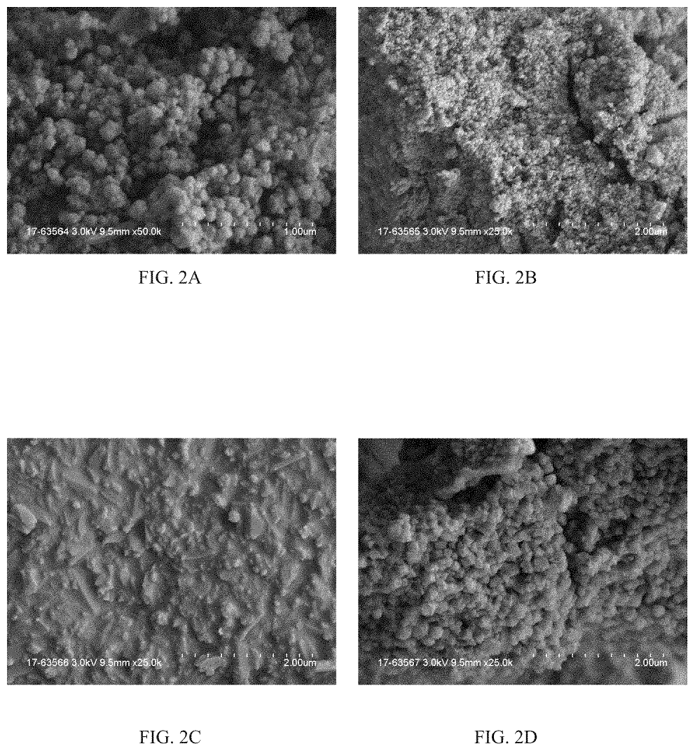

FIG. 2A shows an SEM image of MIL-101 (Cr) produced by heating a powder-form precursor mulled without solvent. FIGS. 2B-2D show SEM images of MIL-101 (Cr) produced by heating a powder-form precursor mulled with DMF, water, or ethanol, respectively. Consistent with the x-ray powder diffraction data, the SEM images of the MIL-101 (Cr) formed from a solvent-free precursor or an ethanol-containing precursor were highly crystalline and of comparable morphology. The MIL-101 (Cr) formed in the presence of DMF or water, in contrast, was much less crystalline in appearance, as evident from the SEM images.

### Example 2: Milling-Based Synthesis of MIL-101 (Cr)

Example 1 was repeated except for blending the metal salt and the multidentate organic ligand by milling instead of mulling.

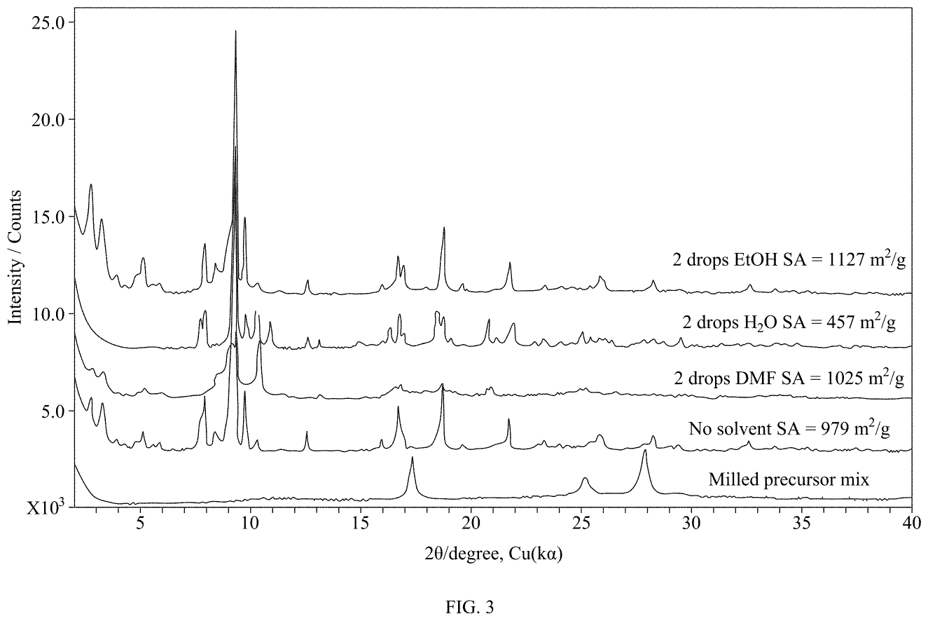

FIG. 3 shows overlaid x-ray powder diffraction patterns for a powder-form precursor of MIL-101 (Cr) obtained by milling and the corresponding metal-organic framework obtained after heating several precursor variants. As shown, the powder-form precursor exhibited a considerably different x-ray powder diffraction pattern than did the products obtained after heating. Notably, the powder-form precursor obtained by milling was considerably less crystalline than that obtained by mulling, as evidenced by the broadness of the x-ray powder diffraction peaks compared to those of the mulled powder-form precursor (see FIG. 1). In addition, there were considerably more peaks present in the x-ray powder diffraction patterns of the MIL-101 (Cr) produced from a milled powder-form precursor after heating compared to that obtained from a mulled powder-form precursor. Like the mulling process of Example 1, the milled samples produced without solvent or containing ethanol showed the greater crystallinity and higher BET surface areas than did those formed in the presence of DMF or water.

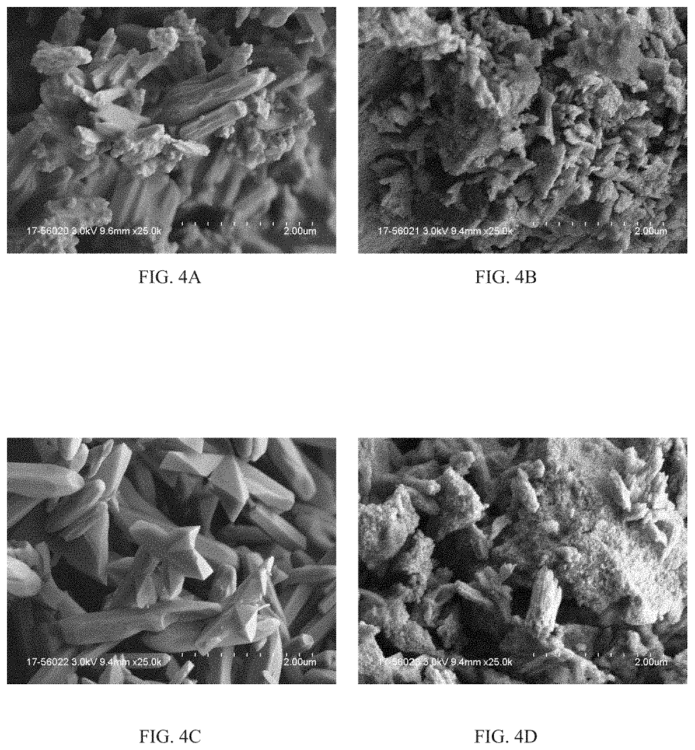

FIG. 4A shows an SEM image of MIL-101 (Cr) produced by heating a powder-form precursor milled without solvent. FIGS. 4B-4D show SEM images of MIL-101 (Cr) produced by heating a powder-form precursor milled with DMF, water, or ethanol, respectively. Consistent with the x-ray powder diffraction data, the SEM images of the MIL-101 (Cr) formed from a solvent-free precursor or an ethanol-containing precursor were highly crystalline and of comparable morphology. The MIL-101 (Cr) formed in the presence of DMF or water, in contrast, was much less crystalline in appearance in the SEM images. The product formed in the presence of water was particularly non-porous.

### Example 3: Mulling-Based Synthesis of MIL-53 (Al) Using Aluminum Nitrate

Example 1 was repeated except for synthesizing MIL-53 (Al) by blending aluminum nitrate and terephthalic acid by mulling to produce the powder-form precursor.

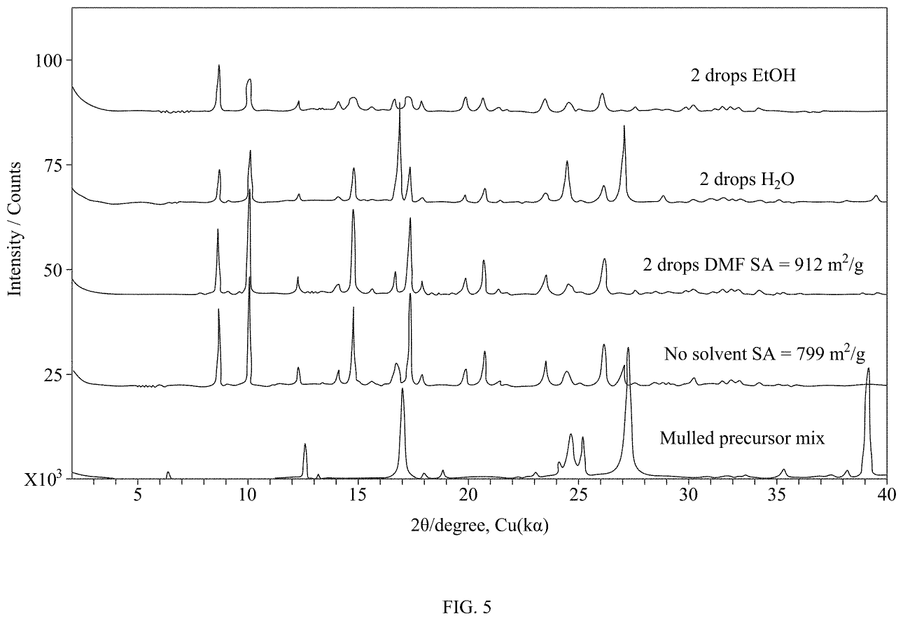

FIG. 5 shows overlaid x-ray powder diffraction patterns for a powder-form precursor of MIL-53 (Al) obtained by mulling a mixture of aluminum nitrate and terephthalic acid and the corresponding metal-organic framework obtained after heating several precursor variants. As shown, the powder-form precursor of MIL-53 (Al) exhibited a considerably different x-ray diffraction pattern than did the products obtained after heating. Specifically, the x-ray powder diffraction patterns obtained after heating were characterized by ingrowth of peaks at 20 values of approximately 8.89, 10.29, 15.16, 17.82, 20.41, 21.27, and 24.20 degrees, whereas none of these peaks were present in the powder-form precursor. Several peaks were present in the x-ray powder diffraction patterns of both the powder-form precursor and the MIL-53 (Al) formed after heating. The MIL-53 (Al) formed without solvent and in the presence of DMF exhibited a comparable extent of crystallinity, as shown by the sharpness of their x-ray powder diffraction peaks. Only modest peak broadening occurred in the x-ray powder diffraction patterns when the powder-form precursor was produced in the presence of water or ethanol. The BET surface area of the MIL-53 (Al) formed from a DMF-containing powder-form precursor was modestly higher than that formed without solvent.

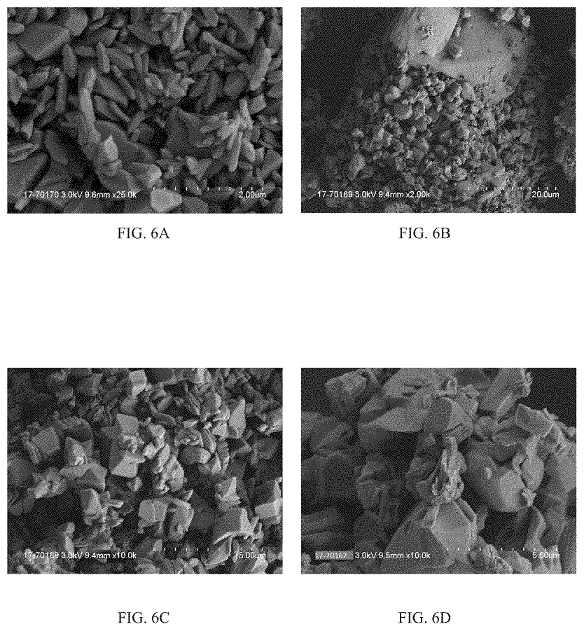

FIG. 6A shows an SEM image of MIL-53 (Al) produced by heating a powder-form precursor obtained by mulling a mixture of aluminum nitrate and terephthalic acid without solvent. FIGS. 6B-6D show SEM images of MIL-53 (Al) produced by heating a powder-form precursor obtained by mulling a mixture of aluminum nitrate and terephthalic acid with DMF, water, or ethanol, respectively. The SEM images showed a similar structural morphology in each case.

### Example 4: Mulling-Based MOF Synthesis of MIL-53 (Al) Using Aluminum Hydroxide

Example 3 was repeated except for substituting aluminum hydroxide for aluminum nitrate to synthesize MIL-53 (Al).

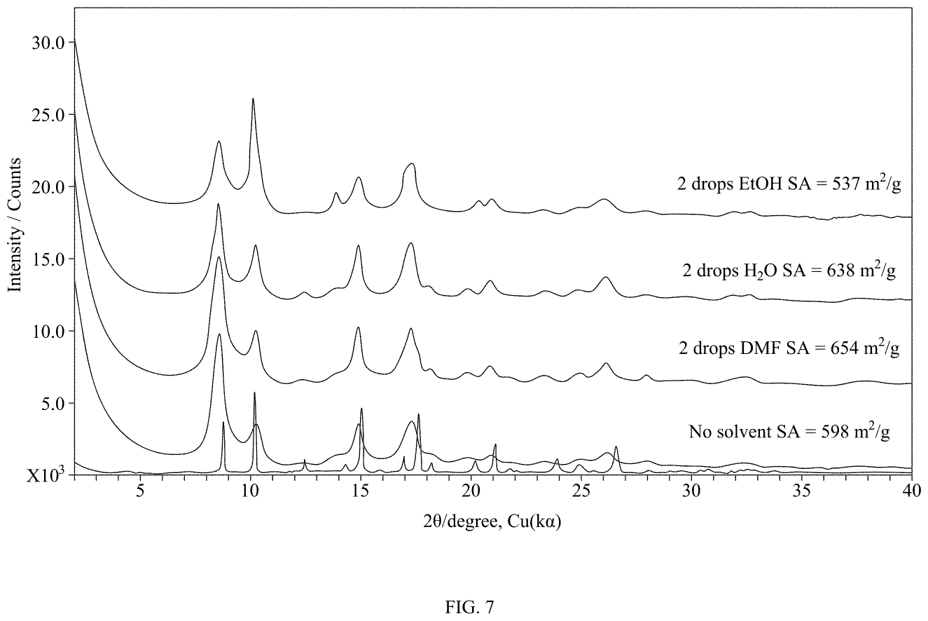

FIG. 7 shows overlaid x-ray powder diffraction patterns for a powder-form precursor of MIL-53 (Al) obtained by mulling a mixture of aluminum hydroxide and terephthalic acid and the corresponding metal-organic framework obtained after heating several precursor variants. As shown, the powder-form precursor of MIL-53 (Al) exhibited a considerably different x-ray powder diffraction pattern than did the products obtained after heating. Notably, the powder-form precursor of MIL-53 (Al) produced using aluminum hydroxide differed significantly from that produced using aluminum nitrate (see FIG. 5 and Example 3). Despite a different powder-form precursor being produced, heating the powder-form precursor again yielded MIL-53 (Al), albeit with a smaller crystallite size than in Example 3. The MIL-53 (Al) obtained after heating the powder-form precursor variants exhibited x-ray powder diffraction peaks at 20 values of approximately 8.64, 10.32, 15.01, and 17.46 degrees, each of which showed significant peak broadening. These peaks each roughly corresponded to some of the peaks present in MIL-53 (Al) produced using an aluminum nitrate powder-form precursor (Example 3). The BET surface areas were fairly comparable to one another and were lower than those produced in Example 3.

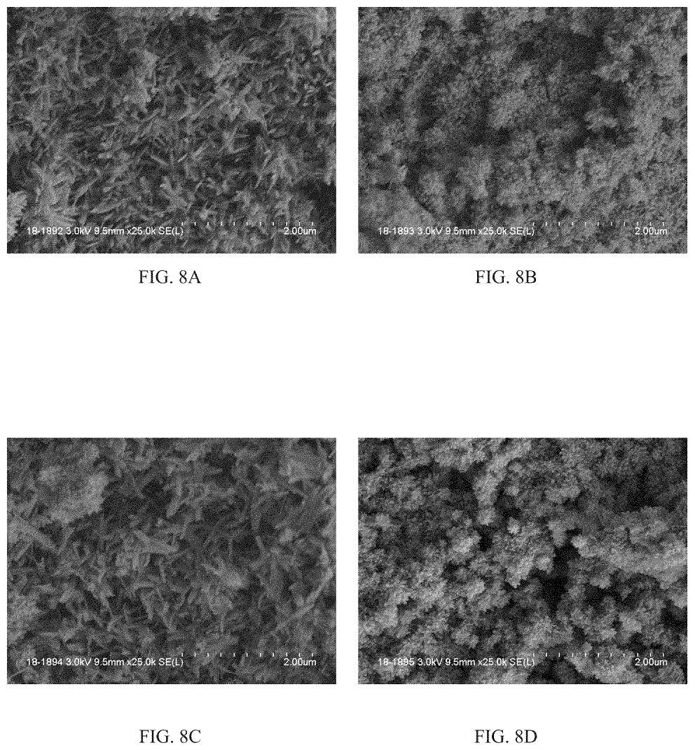

FIG. 8A shows an SEM image of MIL-53 (Al) produced by heating a powder-form precursor obtained by mulling a mixture of aluminum hydroxide and terephthalic acid without solvent. FIGS. 8B-8D show SEM images of MIL-53 (Al) produced by heating a powder-form precursor obtained by mulling a mixture of aluminum hydroxide and terephthalic acid with DMF, water, or ethanol, respectively. The SEM images showed a similar structural morphology in each case, possibly indicative of nanocrystallinity.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A method comprising:
providing a substantially solid mixture comprising a metal salt and a multidentate organic ligand; and
mulling or milling the substantially solid mixture for a sufficient length of time to produce a powder-form precursor of a metal-organic framework, the powder-form precursor being substantially free of the metal-organic framework and comprising a reaction product of the metal salt and the multidentate organic ligand.

2. The method of claim 1, wherein the substantially solid mixture is milled and milling takes place at a constant pressure applied upon the substantially solid mixture by a mill.

3. The method of claim 1, wherein the substantially solid mixture is mulled and mulling takes place at a non-constant pressure applied upon the substantially solid mixture by a muller.

4. The method of claim 1, wherein the substantially solid mixture further comprises a solvent.

5. The method of claim 4, wherein an amount of the solvent in the substantially solid mixture is about 20 μL or above per gram of a combined amount of the metal salt and the multidentate organic ligand.

6. The method of claim 1, wherein the powder-form precursor is at least partially crystalline.

7. The method of claim 1, further comprising:
heating the powder-form precursor for a sufficient time and at a sufficient temperature to convert the powder-form precursor into the metal-organic framework;
wherein heating takes place without applying shear to the powder-form precursor.

8. The method of claim 7, further comprising:
forming the powder-form precursor into a shaped body prior to heating.

9. A method comprising:
providing a substantially solid mixture comprising a metal salt and a multidentate organic ligand; and
mulling the substantially solid mixture at a non-constant pressure applied by a muller for a sufficient length of time to produce a powder-form precursor of a metal-organic framework, the powder-form precursor being substantially free of the metal-organic framework and comprising a reaction product of the metal salt and the multidentate organic ligand.

10. The method of claim 9, further comprising:
heating the powder-form precursor for a sufficient time and at a sufficient temperature to convert the powder-form precursor into the metal-organic framework;
wherein heating takes place without applying shear to the powder-form precursor.

11. The method of claim 10, further comprising:
forming the powder-form precursor into a shaped body prior to heating.

12. The method of claim 9, wherein the substantially solid mixture further comprises a solvent.

13. The method of claim 12, wherein an amount of the solvent in the substantially solid mixture is about 20 μL or above per gram of a combined amount of the metal salt and the multidentate organic ligand.

14. The method of claim 9, wherein the powder-form precursor is at least partially crystalline.

15. A method comprising:
providing a powder-form precursor of a metal-organic framework, the powder-form precursor being substantially free of the metal-organic framework and comprising a reaction product of a metal salt and a multidentate organic ligand; and
heating the powder-form precursor for a sufficient time and at a sufficient temperature to convert the powder-form precursor into the metal-organic framework.

16. The method of claim 15, wherein providing the powder-form precursor comprises milling a substantially solid mixture of the metal salt and the multidentate organic ligand at a constant pressure applied by a mill.

17. The method of claim 15, wherein providing the powder-form precursor comprises mulling a substantially solid mixture of the metal salt and the multidentate organic ligand at a non-constant pressure applied by a muller.

18. The method of claim 15, wherein heating takes place without applying shear to the powder-form precursor.

19. The method of claim 15, further comprising:
forming the powder-form precursor into a shaped body prior to heating.

20. The method of claim 15, wherein the powder-form precursor is produced in the presence of a solvent.

21. A powder-form precursor of a metal-organic framework prepared by a process comprising:
providing a substantially solid mixture comprising a metal salt and a multidentate organic ligand; and
mulling or milling the substantially solid mixture for a sufficient length of time to produce a powder-form precursor of a metal-organic framework, the powder-form precursor being substantially free of the metal-organic framework and comprising a reaction product of the metal salt and the multidentate organic ligand.

22. The powder-form precursor of claim 21, wherein the substantially solid mixture is milled and milling takes place at a constant pressure applied upon the substantially solid mixture by a mill.

23. The powder-form precursor of claim 21, wherein the substantially solid mixture is mulled and mulling takes place at a non-constant pressure applied upon the substantially solid mixture by a muller.

24. The powder-form precursor of claim 21, wherein the powder-form precursor is produced in the presence of a solvent.
